(19) United States
(12) Patent Application Publication
(10) Pub. No.: US 2012/0122646 A1
(43) Pub. Date: May 17, 2012

(54) PROCESS FOR THE ERECTION OF A CARDBOARD BOX BLANK AND EQUIPMENT FOR EFFECTING THE SAME

(75) Inventor: Pascal Murano, Octeville-sur-mer (FR)

(73) Assignee: SIDEL PARTICIPATIONS, Octeville-sur-mer (FR)

(21) Appl. No.: 13/387,581

(22) PCT Filed: Jul. 15, 2010
(86) PCT No.: PCT/FR2010/051488

§ 371 Date: Jan. 27, 2012

(30) Foreign Application Priority Data
Jul. 29, 2009 (FR) 09/55309

(51) Int. Cl. B31B 1/78

(52) U.S. Cl. 493/309

(57) ABSTRACT

A process for erecting a cardboard box blank into the form of a case for the manufacture of a shipping-type cardboard box, together with equipment for its implementation. The process includes the following stages: drawing off a blank having an inscription in standard or reverse form from a stand using a first extractor arm, holding this first arm in contact with a first side of the blank and then placing a second arm on a second side of the blank, the second side being opposite the first side. The process includes operation of a control mechanism after application of second arm to erect a blank having an inscription in standard or reverse form into the form of a case, the control mechanism activating the first extractor arm or the second arm to open the blank.

The invention relates to the erection of a cardboard box blank for the manufacture of a shipping-type cardboard box; it also relates to equipment for implementing the process according to the invention.

A blank for the manufacture of a shipping-type cardboard box comprises two opposing flat walls connected by their lateral edges, each of said walls comprising two adjacent sides of the box which has to be formed, the two adjacent sides being of different lengths (for example a short side and a long side of the box).

Such a blank can be used to first form a case, and this case can then be filled with the products which have to be packed and sealed.

A process for the erection of cardboard box blanks such as that mentioned above comprising a first stage comprising a blank presented in a particular position from a stand using a first extractor arm is known from document FR 2 907 100.

This “fixed” position is selected in advance so that the case formed (at the end of the process) is positioned in a direction so that it can for example be filled by placing items in from the side (for example bottles on their sides). In such a situation the case is arranged in such a way that the inscription it bears can be read from the bottom up.

It should be understood that the “fixed” position may differ. For example it might be such that the case formed (at the end of the process) is positioned such that the case can be filled from above or below. In such a situation the case is arranged in such a way that the inscription it bears can be read from left to right.

According to document FR 2 907 100 a first stage in drawing-off cardboard box blanks consists of performing the following sub-stages:
placing a first extractor aim on a first side of a first wall of the cardboard box blank,
activating first holding means provided on the first extractor arm to hold said first side removed, and
moving said blank to an erection station.

The process described in document FR 2 907 100 also comprises the following stages intended for erecting said box into the form of a case.

These stages are as follows:
placing a second arm on a second side of the second wall, the second side being of a different length from that of the first side;
activating second holding means provided on said second arm to hold said second side;
erection of the cardboard box blank to form a case by maneuvering the extractor arm, that is to say the first arm, by causing it to pivot about an axis in order to open up the blank.

The “fixed” position in this embodiment is a position such that the cases lie on one side (the long side of the box lies horizontally) and they are filled from the side.

Such a process makes it possible to obtain correctly orientated cases for filling with products downstream.

Such a process is therefore satisfactory for companies packing products in shipping-type cardboard boxes.

There is however one situation for which the process described above is not suitable—it is unable to provide correctly orientated cases at the end of the process when the cardboard box blanks stacked in the stand are blanks which are the wrong way round.

The invention therefore arises from the need to provide equipment that is capable of erecting such blanks when they occur.

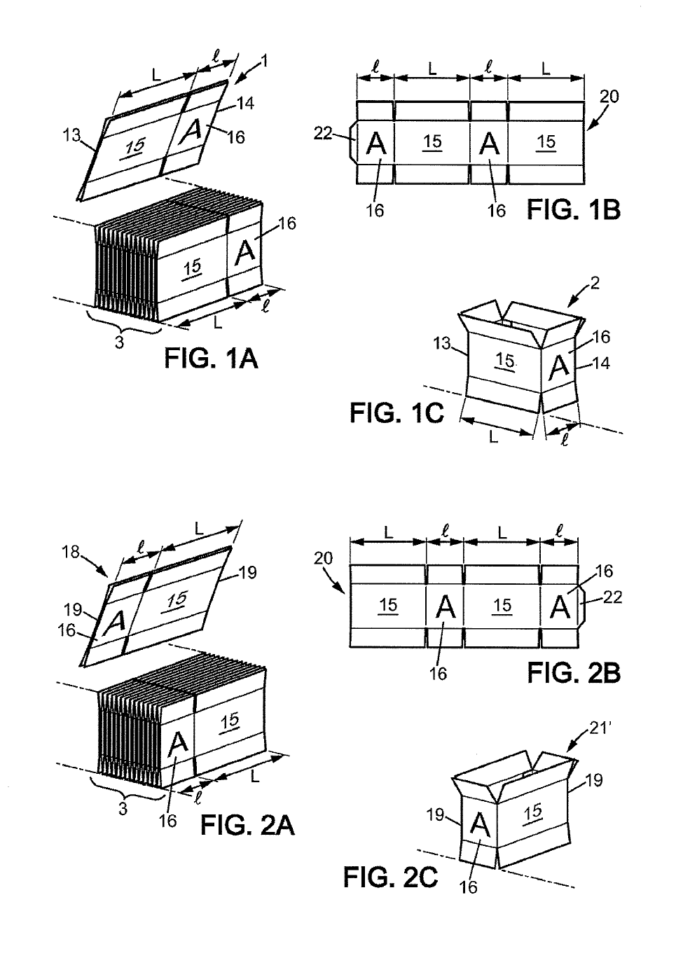

FIG. 1A shows a cardboard box blank on which the inscription has been provided in standard form, and FIG. 2A shows a cardboard box blank on which the inscription is in reverse (and back to front) form.

It will be noted from FIG. 1A that the long side 15 of the box which has to be formed, of length L, lies on the left-hand side of the blank, whereas in FIG. 2A the long side 15 of the box is on the right.

The blank shown in FIG. 1A is taken to be a blank with an inscription in standard form, and the blank shown in FIG. 2A is a blank having an inscription in reverse form.

The blank illustrated in FIG. 1A is obtained from an extended blank 20 illustrated in FIG. 1B. It will be noted that the inscription A is located on the short sides 16 of extended blank 20 and that inscription A is applied when extended blank 20 is laid out with a gluing tab 22 on the left.

The blank illustrated in FIG. 2A is obtained from an extended blank 20 identical to that shown in FIG. 1B, but extended blank 20 is the other way round when inscription A is placed on small side 16. In fact, inscription A is applied when extended blank 20 is laid flat with gluing tab 22 on the right.

The cardboard box blanks (with a standard or reverse inscription) are produced by bringing together long sides 15 and short sides 16 furthest from each other and attaching them by gluing tab 22 onto the edge of long side 15.

We thus obtain blanks having two walls, one of which includes tab 22, this tab being located between the ends of the wall in said central part.

As the cardboard box blanks are placed in the stand and can be read in a predetermined direction, batches of blanks as shown in FIGS. 1A and 2A can then be found in the same stand.

It will then be understood that the extractor arm as defined above can take hold of a blank by its long side 15 or by its short side 16, depending upon whether the cardboard box blank presented to it is a blank as illustrated in FIG. 1A (blank with standard inscription) or a blank as illustrated in FIG. 2A (blank with reverse inscription).

The case produced by the process described in document FR 2 907 100 will not be orientated in the same way, depending upon whether the cardboard blank is picked up by its long side or its short side.

If the case is not correctly orientated it cannot be filled.

FIG. 1C shows in particular that a case obtained from the blank having a standard inscription is orientated in a particular position at the end of the known process and FIG. 2C shows that a case obtained from a blank with a reverse inscription is orientated at an angle of 90° with respect to the orientation of the case in FIG. 1C.

The aim of the invention is to overcome this problem and to produce correctly orientated cases regardless of whether the blanks (present in the stand) are blanks with a standard inscription or a reverse inscription.

In particular it relates to a process and equipment for implementing this process in which the arms are multi-purpose arms, that is to say they are capable of holding the cardboard box blank and erecting it.

For this purpose the invention relates to a process of the type defined above and described in document FR 2 907 100 which is noteworthy in that after the second holding means of the second arm have been activated (during the erection stage) it comprises using control means to erect a blank having an inscription in a standard or reverse form into the form of a case by operating an erecting arm, said arm being the first extractor arm or the second extractor arm as appropriate.

Thus the control means ensure the orientation of the first side of the box and the second side of the box in a predetermined direction, as the operator selects, and in this way the cases obtained are in the desired position, appropriate for filling, which may be effected from above, beneath or from the side.

For example, thanks to the process according to the invention it is possible by activating the control means in their first operating mode or their second operating mode to choose to orientate the arm holding the long side of the box to for example set the box down on a surface on its long side, or conversely on its short side, by choosing to orientate the arm holding the short side of the box.

The process according to the invention may comprise the following characteristics separately or in combination:
a) the process comprises operating the control means to orientate a blank having an inscription in standard or reverse form longitudinally into the form of a case, said control means activating the erecting arm which is, as appropriate:
   the first extractor arm in the case of a blank having a standard inscription;
   or the second arm in the case of a blank having a reverse inscription;
b) the process comprises operating the control means to orientate a blank having an inscription in standard form or reverse form transversely into the form of a case, said control means operating the erecting arm which is, as appropriate:
   the second arm in the case of a blank having a standard inscription,
   or the first extractor arm in the case of a blank having a reverse inscription.

The invention also relates to equipment for implementing the process described above which makes it possible to erect cardboard blanks for shipping-type cardboard boxes in the form of cases, the blanks each comprising two opposite walls connected by their lateral edges, each of the walls comprising two adjacent sides of the box which is to be formed, the two adjacent sides having different lengths, said equipment comprising:
a stand for storing said blanks which can receive, stack and deliver said blanks according to a first-in first-out process,
a bench for the erection of blanks drawn from said stand in the form of cases, this bench being located between said stand for said blanks and a station designed for filling the cases obtained after said blanks have been erected,
a trolley which can move longitudinally along said bench, said trolley comprising:
   a first orientatably mounted extractor arm capable of drawing a blank stored in said stand by a first side of a first wall of the blank and holding said first side to move the blank to an erecting station and,
   a second orientatably mounted arm capable of holding a second side of a second wall opposite said first wall at said erecting station.

According to the invention the equipment is noteworthy in that it comprises control means for erecting standard or reverse blanks into the form of a case, said control means being capable of operating an erecting arm, said arm being the first extractor arm or said second arm as appropriate.

According to an advantageous embodiment of the equipment according to the invention said control means may be provided upstream of said equipment, in the vicinity of said stand. Thus, a user may operate the control means according to the cardboard box blanks present in the stand—the user will thus see whether the blanks are of the standard or reverse type and, according to what he sees and the orientation which he desires to obtain for the box, will operate the control means accordingly.

The invention will be further understood from an embodiment of the process according to the invention which will now be described with reference to the appended figures in which:

FIGS. 1A to 1C relate to a blank having an inscription in standard form, FIG. 1A showing in perspective view a stand in which said blanks are stacked; FIG. 1B showing an extended box blank in front view which will yield a blank with an inscription in standard form and FIG. 1C showing a case obtained at the end of the process known and described in document FR 2 907 100;

FIGS. 2A to 2C relate to a blank with a reverse inscription; FIG. 2A showing a stand in which such blanks are stacked, in perspective view; FIG. 2B showing in front view an extended box blank which will yield a blank with a reverse inscription, and FIG. 2C showing a case obtained as a result of the process known and described in document FR 2 907 100;

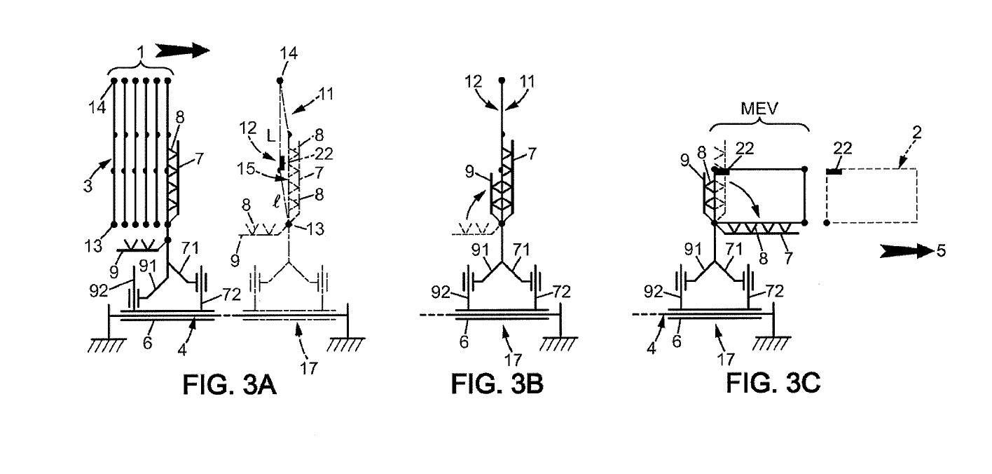

FIGS. 3A to 3C illustrate the stages in the known process described in document FR 2 907 100, and they show diagrammatically in a view from above a stand in which cardboard box blanks with an inscription in standard form (blanks such as those illustrated in FIG. 1A) are stored, together with an erection station; FIG. 3A illustrating the stage of drawing a blank from the stand; FIG. 3B showing a stage prior to the erection stage and FIG. 3C showing a stage of erection according to a first operating mode,

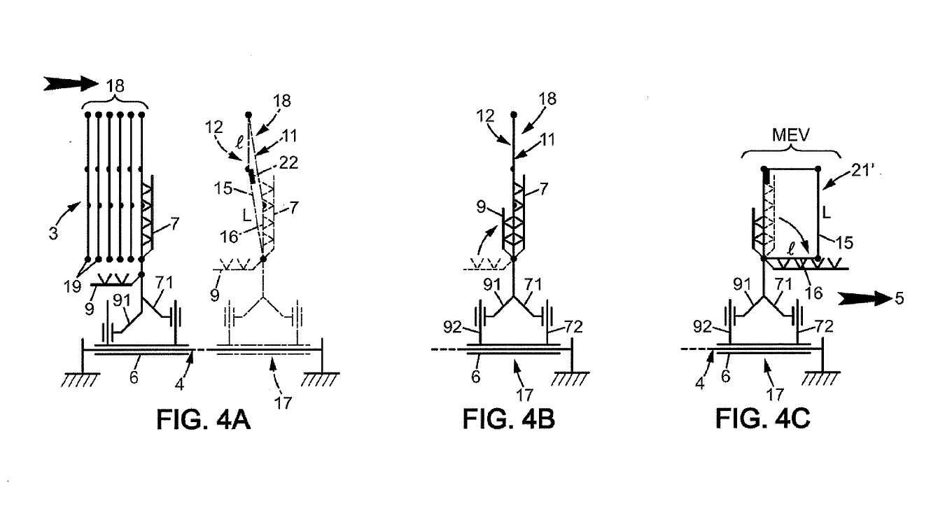

FIGS. 4A to 4C illustrate stages in the known process described in document FR 2 907 100 and show diagrammatically in a view from above a stand in which cardboard box blanks with an inscription in reverse form (blanks such as those illustrated in FIG. 2A) are stored, together with an erection station,

FIGS. 4A to 4C illustrating the same stages as those illustrated in FIGS. 3A to 3C for erecting the blank,

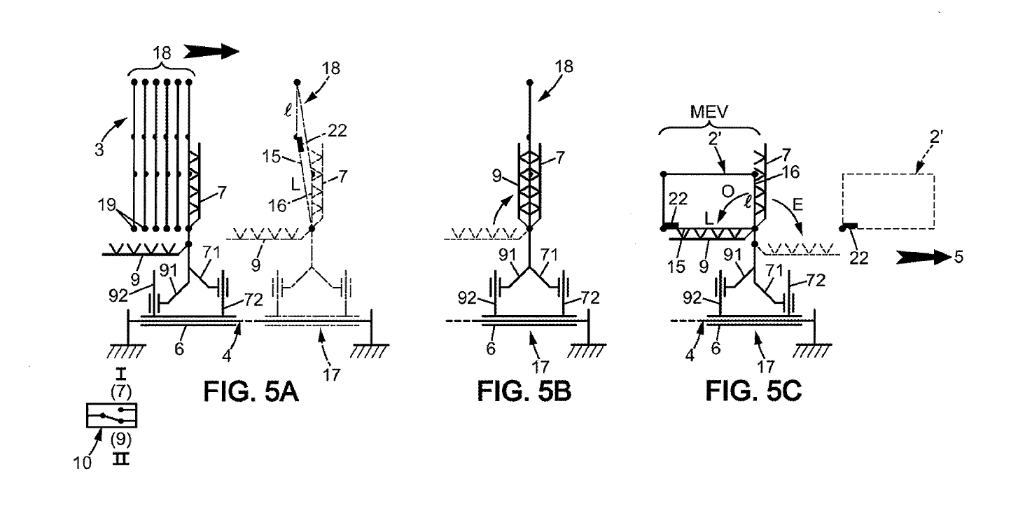

FIGS. 5A to 5C illustrate stages in the process according to the invention, in a diagrammatical view from above, a stand in which cardboard box blanks with an inscription in reverse form (blanks such as those illustrated in FIG. 2A) are stored together with an erection station; FIG. 5A showing the stage of drawing the cardboard box blank; FIG. 5B showing the stage prior to erection and FIG. 5C showing the stage of erection in response to the activation of control means,

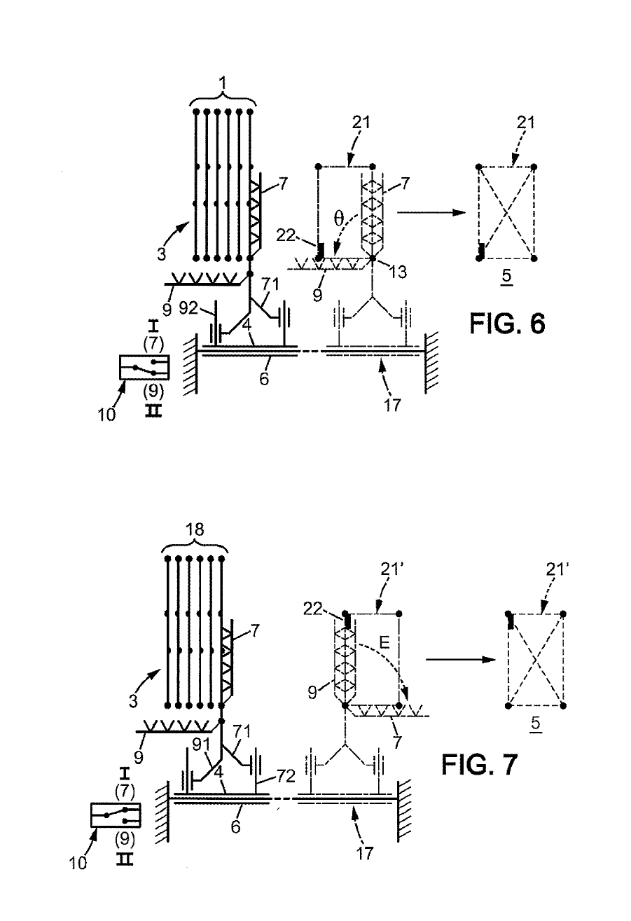

FIG. 6 illustrates diagrammatically how to obtain a transversely orientated case from blanks having an inscription in standard form stacked in the stand by activating a first operating mode of the control means,

FIG. 7 illustrates diagrammatically how to obtain a case orientated in the same way as FIG. 6 from blanks having inscriptions in reverse form by operating a second operating mode of the control means,

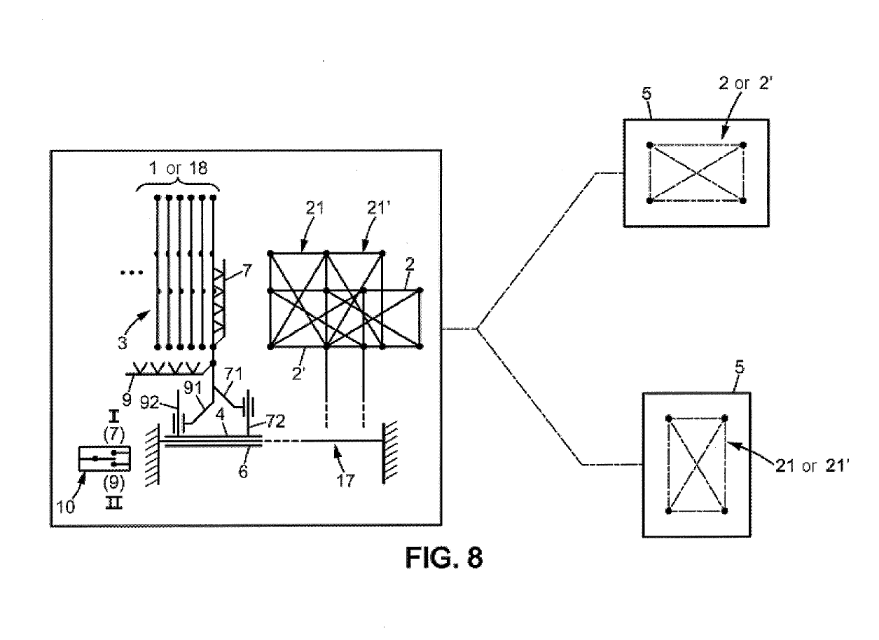

and FIG. 8 illustrates diagrammatically all the case orientations which may be obtained using the equipment according to the invention or by implementing the process according to the invention.

First of all a known erection process applied to a cardboard box blank 1 such as that illustrated in FIG. 1A will be described.

In order to simplify this description it is to be understood that blanks such as those illustrated in FIG. 1A are known as “standard blanks” and that blanks such as those illustrated in FIG. 2A are known as “reverse blanks”. It should however be understood that these names have only been selected in order to distinguish them, and that the standard blanks may be those illustrated in FIG. 2A without this affecting the invention.

The equipment according to the invention makes it possible to implement a known process for the erection of blanks 1 of standard type.

The various stages in this process are illustrated in FIGS. 3A to 3C.

Cases 2 which are conveniently orientated for filling, these cases being orientated in the same way as case 2 illustrated in FIG. 1C or 3C, may be obtained by the known process.

By “conveniently” is meant that the case obtained is orientated in a predetermined direction, that is to say in a direction in which it is capable of being filled.

In the context of the example which will be described the predetermined position of the cases is the position illustrated in FIG. 1C or 3C, that is to say orientated longitudinally, or in other words a position in which the long side of the case is orientated in the direction in which it is conveyed, illustrated in particular by the arrow in FIG. 3C, with its inscription orientated in such a way that it can be read from left to right.

Cardboard box blanks 1 can be used to form “shipping”-type cardboard boxes, that is to say boxes having two opposing walls 11 and 12 (see FIG. 3A) connected by their lateral edges 13 and 14 (see FIGS. 1A and 3A).

Each of walls 11 and 12 comprises two adjacent sides 15 and 16 of the box which will be formed, said adjacent sides 15 and 16 having lengths L and l respectively, which are different (see in particular FIGS. 1A and 1B).

In FIGS. 3A to 3C, cardboard box blanks 1 with “standard” inscriptions are all stacked with the same orientation in a stand 3.

For example, blanks 1 are stacked in stand 3, being orientated in such a way that the inscription on them is read from left to right.

Stand 3 is a stand designed to deliver the blanks on the basis of a FIFO (First-In First-Out) process, that is to say the first cardboard box blanks 1 placed in it are the first to be taken out.

As will be seen in FIGS. 3A to 3C the equipment also includes a bench 4 for the erection of cardboard box blanks 1 in the form of cases 2.

Erection bench 4 is located between stand 3 and the station 5 intended for filling cases 2 obtained after erection.

The arrow in FIG. 3C shows the direction in which they are conveyed, as indicated previously, but also the movement of shaped case 2 towards filling station 5.

The equipment according to the invention also has a trolley 6 which moves longitudinally on bench 4.

Trolley 6 is fitted with various components which draw, erect and remove cardboard box blanks 1 taken from stand 3.

First of all, trolley 6 has a first arm 7 which draws a cardboard box blank 1 from stand 3.

To effect this, first arm 7 is equipped with vacuum cups 8 connected to means capable of extracting air. These means have not been shown in order to simplify reading of the figures. Their construction and use are known to those skilled in the art.

First arm 7 is mounted in an articulated (or orientatable) way on trolley 6 through a mechanism of the type described in aforesaid document FR 2 907 100 to pivot about a virtual axis.

Trolley 6 comprises a second arm 9, also orientatably mounted through a mechanism identical to that for arm 7, to pivot about a virtual axis.

Second arm 9 is also fitted with suction cups 8 associated with an extraction system for reasons which will be described below.

Arms 7 and 9 are of different lengths, arm 7 being longer than arm 9.

Each of first and second arms 7 and 9 are mounted at the extremity of an angled member, 71 and 91 respectively, angled members 71 and 91 themselves being mounted so as to move on rails, 72 and 92 respectively, attached to trolley 6.

In the figures, in particular 3A to 3C, angled members 71 and 91 are one above the other, being shown in a view from above. It should however be understood that the movements of angled members 71 and 91 on rails 72 and 92 are independent.

The back and forth movement of angled member 91 makes it possible to pass arm 9 beneath stand 3 or to place its virtual pivot axis in a plane which allows it to grasp a blank 1, or again to leave a space between the cardboard box blank being erected and arm 9 to release case 2 obtained so that it is delivered to filling station 5.

The back and forth movement of angled member 71 makes it possible to provide a space between the cardboard box blank which is being erected and arm 7 to release case 2 obtained so that it can be delivered to filling station 5.

The known process for forming a case 2 will now be described with reference to FIGS. 3A to 3C.

Firstly, a trolley 6 is moved on bench 4 to stand 3 where blanks 1 (with standard type inscriptions) are stacked.

In order to do this, first arm 7, fitted with suction cups 8, is orientated along a plane substantially parallel to that of blanks 1 stacked in stand 3 and angled member 71 is in a position away from trolley 6 so that first arm 7 is wholly opposite a box.

Angled member 91 is in a position close to trolley 6, that is to say that arm 9 is away from the edge 13 of blanks 1 in stand 3.

Furthermore, second arm 9, also fitted with suction cups 8, is orientated perpendicular to the first arm so that it slides along the side of stand 3 when trolley 6 is in the vicinity of the latter.

Blanks 1 are positioned in stand 3 with their edges 13 and 14 perpendicular to the edge of stand 3, and the inscriptions on them are read from left to right.

With blanks 1 positioned in stand 3 in this way, it is the long sides 15 of blanks 1 which lie opposite first arm 7 of trolley 6 when first aim 7 picks up a blank 1.

In accordance with a first stage of the erection process, first arm 7 is placed on the first side of wall 11 of the blank that it comes into contact with.

In the situation illustrated in FIG. 3A, the first side is the long side 15 of blank 1.

Long side 15 is then seized by first arm 7 by activating the holding means comprising suction cups 8 and the extraction means associated with suction cups 8 (extraction means not shown).

Blank 1 is then moved through a particular distance up to a point corresponding to erection station 17 through lateral movement of trolley 6 on bench 4.

In the case of the operating mode of the equipment currently being described, the so-called “particular” distance is at least the length of arm 9, to ensure that it is released so that it can pivot, as will now be explained.

In FIG. 3B, blank 1 is held at erection station 17 by first arm 7 by means of suction cups 8.

In accordance with the known process, angled member 91 moves on rail 91 to bring the virtual pivot axis of second arm 9 substantially into the same plane as that of the virtual pivot axis of arm 7. In other words, angled member 91 is moved away from trolley 6.

Then second arm 9 is brought up against second wall 12 of blank 1 by pivoting about its articulated extremity (virtual axis). The pivoting of second arm 9 is shown symbolically by the arrow in FIG. 3B.

Second arm 9 then holds the side of wall 12 of blank 1 facing it by using suction cups 8 and the extraction means.

The side of the box opposite second arm 9 is the short side 16 of the blank which is to be erected.

FIG. 3C shows the third stage in the main process, which comprises pivoting first arm 7 holding long side 15 of blank 1 through 90° about its extremity in a direction inverse to the trigonometric direction.

As first and second arms 7 and 9 hold long and short sides 15 and 16 respectively, pivoting of first arm 7 causes blank 1 to open and form case 2.

Once case 2 has formed, it is moved to filling station 5.

In order to do this, suction cups 8 are deactivated and the two arms 7 and 9 are moved away from case 2 which has been obtained, by the movement of angled members 91 and 71 on rails 92 and 72.

The known process which has just been described and which can be implemented by means of equipment according to the invention does not make it possible to produce cases which are correctly orientated (in the example described) in order to be filled when the cardboard box blanks are blanks 18 of the reverse type as previously described and illustrated in FIG. 2A.

This will be understood from the description which will now be provided with reference to FIGS. 4A to 4C.

Stand 3 is filled with blanks 18 which are orientated in the same way as blanks 1, that is to say blanks 18 are located in stand 3 in such a way that their two lateral edges 19 are located perpendicularly to the edge of the stand and that the inscriptions on blanks 18 are read from left to right (see FIGS. 4A and 2A).

Applying the process implemented in FIGS. 3A to 3C and making the necessary changes, blanks 18 are picked up one by one from stand 3 by first arm 7, by placing first arm 7 on the wall 11 of blanks 18 and in particular on the side opposite first arm 7 when trolley 6 is moved into the vicinity of stand 3.

The side of blank 18 facing first arm 7 is short side 16. It is therefore by short side 16 that blank 18 is picked up by first arm 7.

In accordance with the known process, trolley 6 is moved to erection station 17.

Second arm 9 is then placed on the other wall 12 of blank 18 by pivoting about its extremity.

The holding means of second aim 9 are activated so that second arm 9 holds the side of the blank against which it is laid.

In the case described, the side on which second arm 9 is laid is the long side 15 of the box which is to be erected.

Then in the first stage (FIG. 4C) first arm 7 pivots through an angle of 90° in the direction opposite to the trigonometric direction in such a way as to open up cardboard box blank 18.

A case 21′ orientated as illustrated in FIG. 4C is obtained, that is to say it is the short sides 16 which are orientated longitudinally, as shown in FIG. 2C.

This means that case 21′ which is obtained adopts a position which is not appropriate for filling, in a longitudinal configuration of the case, as shown in FIG. 1C.

In order to overcome this inconvenience the process according to the invention uses the control means 10 of the equipment illustrated in FIGS. 5A, 6, 7 and 8.

Control means 10 are illustrated diagrammatically as a casing.

In this casing there is shown a selector switch which illustrates the two operating modes I and II of control means 10.

The operating mode illustrated in FIGS. 3A to 3C and 4A to 4C corresponds to the operating mode when the selector switch is in position I. In other words, position I controls conventional operation of the equipment, making it possible to implement the known process.

Means 10 may include a switch whose operation orientates the selector switch into either conventional operating mode I or an operating mode II which will be described below, and which is more particularly intended for the erection of blanks without a standard inscription, this inscription being called (in the context of this description, without the adjective being restricting) “reverse inscription”.

Control means 10 are provided upstream of the equipment, in the vicinity of stand 3, so that an operator can observe the blanks and activate one or other of the operating modes of the equipment according to his observations.

Reference will now be made to FIGS. 5A to 5C which show stages in the process used to erect cardboard box blanks 18 in order to obtain cases 2′ which are longitudinally orientated for filling.

In the equipment according to the invention arms 7 and 9 are of substantially the same length, and this length substantially corresponds to the length of the long side L of the box being formed. Thus arms 7 and 9 are suitable for erecting a box by pulling on either the long side of the box or the short side.

In order to choose the mode of operation of the equipment, the operator must first observe that the blanks in stand 3 are blanks 18 of the reverse type.

When the operator establishes this he activates the second operating mode of control means 10 by switching the switch to position II, for example by activating a switch (see the position of the selector switch on control means 10 in FIG. 5A).

As in operating mode I (illustrated in FIGS. 3A to 3C and 4A to 4C), trolley 6 is moved into the vicinity of stand 3 so that first arm 7 is placed upon a wall of a blank 18.

The extraction means are activated and arm 7 seizes blank 18 on the side of the box which has to be formed opposite to it, that is to say short side 16, as shown in FIG. 5A.

Trolley 6 is then moved to erecting station 17 over a particular distance which in the context of this operating mode II is greater than the length of arm 7 or 9.

In a manner which is in itself conventional, when trolley 6 reaches the erecting station second arm 9 is placed on the other wall 12 of blank 18 and the suction holding means are activated so that second arm 9 firmly holds the side of the box which has to be formed lying opposite to it (in this case long side 15).

According to operating mode II for the equipment the following stage comprises orientating second arm 9 and causing it to pivot through an angle of 90° in the trigonometric direction, as shown by the arrow O in FIG. 5C.

This erection stage is different from that in operating mode I, which provides for the orientation of first arm 7, not second arm 9.

It should also be noted that second arm 9 is orientated by rotating through an angle of 90° in the trigonometric direction, in accordance with operating mode II, whereas according to operating mode I first arm 7 is orientated by rotating through an angle of 90° in the direction opposite to the trigonometric direction.

According to operating mode II, second arm 9 orientates itself longitudinally so as to orientate long side 15 which it holds into a substantially longitudinal position, in the direction in which it is moved on the equipment (see the arrow in the figures).

Case 2′ obtained is thus orientated longitudinally for filling.

To move case 2′ to filling station 5, the suction (holding) means for first and second arms 7 and 9 are deactivated and first arm 7 pivots through an angle of 90° in the direction opposite to the trigonometric direction (see arrow E in FIG. 4C). The two arms are also moved away from case 2′ as a result of the movement of angled members 91 and 71 on rails 92 and 72.

It will be understood that, in order to allow second arm 9 to pivot O in the trigonometric direction, the distance between erection station 17 and stand 3 must be equal to at least the length of arm 9.

It will also be understood that in order to allow first arm 7 to open E in order to remove case 2′ the distance between stand 3 and filling station 5 will be equal to at least the length of first arm 7, which is only used for drawing off blank 18 in operating mode II.

It will be understood from the above description how the invention makes it possible to produce cases orientated in the same way (according to a predetermined direction) using different cardboard box blanks 1 and 18.

It should however be understood that the invention is not restricted to the embodiment specifically described above, and that it extends to the application of any equivalent means.

In particular, it should be understood that the invention is not restricted to the formation of longitudinally orientated cases as illustrated in FIGS. 3C (orientation obtained from a standard blank 1 by activating the control means in operating mode I) and 5C (orientation obtained from a reverse blank 18 by activating the control means in operating mode II).

FIGS. 6 and 7 in particular illustrate cases also obtained by use of the process according to the invention, and these cases are orientated transversely, that is to say such that their short sides 16 are substantially parallel with the direction in which the cases are conveyed longitudinally.

In particular FIG. 6 shows a case obtained at the end of the process according to the invention from standard blanks 1 stacked in stand 3. In order to obtain a transversely orientated case 21 it is small arm 9 (or second arm 9) which is activated by causing it to rotate in the trigonometric direction as shown by arrow O during the stage of erection according to the invention. This rotation (or pivoting) of second arm 9 corresponds to operating control means 10 in second operating mode II. As illustrated in FIG. 6, the distance between stand 3 and erection station 17 must be equal to at least the length of second arm 9.

FIG. 7 shows yet another way of obtaining cases 21′ which are orientated according to their short sides 16 (that is transversely). This orientation of the cases is obtained from reverse blanks by activating control means 10 in first operating mode I. The process used corresponds strictly to that illustrated in FIGS. 4A to 4C.

Finally, FIG. 8 shows all the case orientations which it is possible to obtain from standard or reverse blanks by the process according to the invention.

The process according to the invention thus ensures that the machine is a multipurpose one which can erect standard or reverse blanks to obtain cases orientated in one direction or the other (longitudinally or transversely) depending upon the configuration of the filling station associated with the machine.

In the case of a filling station 5 in which cases 2, 2′ are arranged longitudinally, the operator will select operating mode:

I, for standard blanks 1,

II, for reverse blanks 18.

In the case of a filling station 5 in which cases 21, 21′ are positioned transversely, the operator will choose operating mode:

I, for reverse blanks 18,

II, for standard blanks 1.

The advantage of the invention therefore lies in the fact that packaging companies no longer have to return “reverse” type blanks to their supplier or provide filling stations for the manual erection of such blanks, which in both cases results in additional costs for packaging companies.

The commercial advantage of the invention will thus be understood.

1-5. (canceled)

6. A process for the erection of a cardboard box blank into the form of a case to manufacture a shipping-type cardboard box, said cardboard box blank comprising two opposing walls connected by their lateral edges, each of the walls comprising two adjacent sides of the cardboard box which is to be formed, the two adjacent sides having different lengths, said process comprising stages comprising:
drawing a blank having an inscription in standard or reverse form from a stand using a first extractor arm by:
placing said first extractor arm on at least a first side of a first wall of said cardboard box blank,
activating first holding means provided on said first arm to seize said first side, and
moving said blank to an erection station,
and erecting said cardboard box blank into the form of a case by:
placing a second arm on a second side of a second wall opposite said first wall,
operating second holding means provided on said second arm to hold said second side,
wherein, after activating the second holding means, operating command means are activating to erect a blank having an inscription in standard or reverse form into the form of a case by activating an erecting arm, said arm being, as appropriate:
the first extractor arm,
or the second arm.

7. The erection process as claimed in claim 6, comprising operating control means to orientate a blank having an inscription in standard or reverse form longitudinally into the form of a case, said control means operating erecting arm which according to circumstances is:
first extractor arm in the case of blank having a standard inscription;
or second arm in the case of blank having a reverse inscription.

8. The erection process as claimed in claim 6, comprising operating control means to orientate a blank having an inscription in standard or reverse form transversely into the form of a case, said control means activating the erecting arm which according to circumstances is:
second arm in the case of blank having a standard inscription,
or first extractor arm in the case of a blank having a reverse inscription.

9. Equipment for implementing the process as claimed in claim 6, whereby blanks for shipping-type cardboard boxes can be erected in the form of cases, the blanks each comprising two opposite walls connected by their lateral edges, each of the walls comprising two adjacent sides of the box which is to be formed, the two adjacent sides having different lengths, said installation comprising:
a stand for storage of said blanks which is able to receive, stack and deliver said blanks on the basis of a first-in first-out process,
a bench for the erection of blanks drawn from said stand into the form of cases, this bench being located between said stand storing said blanks and a station intended for filling of the cases obtained after said blanks have been erected,
a trolley which can move longitudinally upon said bench, said trolley comprising:
a first orientatably mounted extractor arm which can draw off a blank stored in said stand by a first side of a first wall of the blank and hold said first side to move the blank to an erection station, and
a second orientatably mounted arm capable of holding a second side of a second wall opposite said first wall in said erecting station,
said equipment comprising control means for erection of standard or reverse blanks into the form of a case,
said control means being capable of activating an erecting arm, said arm being according to circumstances:
the first extractor arm,
or the second arm.

10. The equipment as claimed in claim 9, wherein said control means are located upstream of said equipment, in the vicinity of said stand.
